(19) United States
(12) Patent Application Publication
(10) Pub. No.: US 2015/0201548 A1
(43) Pub. Date: Jul. 23, 2015

(54) Manure Agitation Boat

(71) Applicant: Hydro Operating, LLC, Norwood Young America, MN (US)

(72) Inventors: Kevin L. WOLTER, Belle Plaine, MN (US); Anteneh G. MANO, Minneapolis, MN (US)

(73) Assignee: Hydro Operating, LLC, Norwood Young America, MN (US)

(21) Appl. No.: 14/549,423

(22) Filed: Nov. 20, 2014

Related U.S. Application Data
(60) Provisional application No. 61/906,410, filed on Nov. 20, 2013.

(51) Int. Cl. A01C 3/02; B01F 13/00; B01F 7/00

(52) U.S. Cl. CPC A01C 3/026; B01F 7/00341; B01F 13/0049; B01F 2215/0003

(57) ABSTRACT

Apparatus and methods for mixing the contents of manure storage lagoons. Remotely controlled floating agitation vessels are provided. Some have one or more propellers which are located on the ends of agitator arms where the propellers are driven by motors located at the opposite ends of the arms and having a drive shaft extending through the agitator arms. The agitator arms can be lowered and raised varying degrees and have the propeller speeds varied; both under remote control. Some apparatus are steered using a steering arm coupled to a land secured cable where the orientation of the boat is changed by pivoting the steering arm angle with respect to the cable. Some apparatus are remotely steered by remotely and individually controlling the speed of the propellers. Propeller motors and actuators can be hydraulically driven with the hydraulic fluid and driving engine air cooled using a radiator.

### RELATED APPLICATIONS

The present patent application is a non-provisional patent application of U.S. Provisional Patent Application No. 61/906,410 titled MANURE APPLICATION BOAT filed Nov. 20, 2013, herein incorporated by reference in its entirety.

### TECHNICAL FIELD

The present invention is related generally to management of manure pits. More specifically, the present invention is related to vessels which float on manure ponds and agitate deeper manure. The present invention can include boats which have adjustable depth driven propellers which can stir up thick manure into a slurry mixture suitable for pumping.

### BACKGROUND

Manure pits, ponds or lagoons contain a large amount of manure which settles over time to have a heavy bottom layer and a lighter top layer. Current large manure lagoons or pits often have a 3:1 slope on the sides, which is often lined with a polymeric liner. The pits are often 15 or even 25 feet deep. Some lagoons have a crust of livestock bedding material from the manure on the top which may be 6 or 12 inches deep. A more liquid phase can be about 5 or 6 feet deep in some lagoons. The more solid, settled phase can be located in the bottom ¼ of the lagoon, with the more liquid phase being in the top ¾. These lagoon dimensions are illustrative only as lagoons vary greatly in dimensions and content.

When it is necessary to pump out the manure the top layer can be pumped out without great difficulty. The denser, settled bottom layer presents a much bigger problem. Current methods include using a blower floating on the manure to attempt to dislodge the heavier material into the lighter material. Such methods leave a great deal of heavy material on the bottom. This material must often be removed with skid loaders lowered into the pit. The skid loaders often fill multiple trucks loads of the heavier manure scraped off the bottom. This is extremely expensive and labor intensive. In addition, many pits have polymeric liners that would be damaged by skid loaders/Bobcats running over them and scraping manure.

It would be desirable to pump out all or most of the manure pit contents, but that is not currently feasible. Current pumps often drawn down the lighter layers of manure but soon reach the heavier layers and cavitate, trying to suck out the too heavy manure. This causes expensive damage to the pumps and also disrupts the manure pit emptying process.

As farms grow in size manure pits can become larger, making the middle parts of the pit harder to reach from the edge. This means that previous methods of reaching central portions of the manure pit from the edge no longer work. Some methods use a shore mounted agitator driven by a tractor where the shore located portion of the device is backed down the slope into the lagoon. In particular, current tractor powered systems no longer reach the center of the pit.

Some current methods utilize a vessel mounted downward directed pump discharge to dislodge the settled manure. These methods fail to dislodge enough manure and often fail to provide a mixture that is suitable for pumping.

What would be desirable are methods and devices which can mix the contents of the manure pit into a pumpable slurry which can be pumped out of the pit.

### SUMMARY

Some embodiments of the invention provide an apparatus for dislodging manure from a manure lagoon, the apparatus including: a floating vessel; an engine on the vessel; an arm having a distal end, distal region, proximal region, and proximal end, where the distal end is further from the vessel than the proximal end; and a propeller secured to the arm distal region. A motor can be operably secured to the arm and coupled to the propeller to rotate the propeller; where the arm is coupled to the vessel such that the distal end can be lowered into the lagoon at least 5 feet in depth and in which the propeller can be rotated by the motor after lowering.

In some apparatus the propeller is horizontally distant from the vessel after the lowering by at least one yard. The motor can be disposed near the arm proximal region and the propeller disposed near the arm distal region such that the motor drives the propeller through a drive shaft along the arm. The motor can be disposed in the arm distal region, proximal region, or an intermediate region. In some examples of the invention the arm is at least 10 feet long, and can be lowered at least 30 degrees from horizontal, for example, using a cable and a winch. In other embodiments another elongate member such as a rod could be used to raise and lower the arms. The motor can be a hydraulic motor driven by a hydraulic pump driven by the engine.

Some embodiments include a boat control unit controlling the motor, engine, arm extension/retraction, engine speed, propeller speed, and the arm raising and lowering, were the boat control unit can be controlled remotely, for example from land. A system including a remote control unit for remotely controlling the boat control unit can also be provided.

Some such vessels include at least two propellers, arms, motors, and means for lowering and raising the arms. Other embodiments include at least three propellers, arms, motors, and means for lowering and raising the arms, wherein one of the three propellers is located on the opposite front/rear side of the vessel from the other two propellers. Another embodiment includes at least four propellers, arms, motors, and means for lowering and raising the arms, wherein two of the four propellers are located on the opposite front/rear (fore/aft) side of the vessel from the other two propellers. In some devices the speeds of the propellers can be controlled independently of the other propellers. Such multi-propeller vessels can be steered by varying the speed of the propellers. Propellers can be used for both manure agitation and propulsion of the vessel.

Some boats also have a bottom propeller guard disposed underneath the propeller such that the propeller is prevented from striking a solid surface if the arm is lowered so as to otherwise cause the propeller to strike the solid surface. Boats may have a side propeller guard disposed alongside the propeller such that the propeller is prevented from striking the solid surface if the arm is moved sideways so as to otherwise cause the propeller to strike the solid surface.

Another apparatus for mixing the contents of a manure pit includes: a floating vessel; a first lever arm pivotally coupled to the vessel at a first lever arm first region and having a rotatable propeller disposed near a first lever arm second region outboard of the first region and a first motor disposed on the first lever arm and coupled to drive the first propeller; and a first elongate member coupled at a first region to the vessel and at a second region to the first lever arm, where the first elongate member is configured to raise and lower the first lever arm. In some embodiments the first elongate member includes a first cable which can be secured to a winch.

The first motor can be hydraulically driven and disposed near the first lever arm first region and coupled to the first propeller through a first drive shaft. Some boats also have a second lever arm, second motor, and second propeller, where the first and second motor speeds are independently controllable. Some boats also have a third and fourth lever arm, a third and fourth motor, and a third and fourth propeller.

Some vessels include floatation pontoons. In some vessels the lever arms have a first position such that the lever arms on opposite sides of the vessel are less than 10 feet apart and a second position such that the lever arms on opposite sides of the vessel are greater than 10 feet apart. In some examples of the invention the lever arms have a first position such that the lever arms on opposite sides of the vessel are vertically over at least part of the vessel frame and/or pontoons below and a second position not over the vessel frame and/or pontoons below such that the lever arms on opposite sides of the vessel can be lowered into the manure water mixture on which the vessel floats. In some vessels the lever arms are coupled to actuators which can move the arms between the first and second positions.

The present invention provides methods for agitating manure in a lagoon. One such method includes: agitating the manure using a vessel in the lagoon having a propeller directed toward the lagoon edge where the propeller is rotated so as to urge the vessel away from the lagoon edge; and applying an opposing force to oppose the propeller horizontal force so as to urge the vessel toward the lagoon edge, where the opposing force can both maintain vessel position with respect to the edge and move the vessel closer to the edge. The opposing force is provided in some methods by tension on a tether connected between the vessel and an object disposed beyond the lagoon manure edge. The method can include steering the vessel by varying the location at which the tether is connected to the vessel with respect to the vessel centerline. In some methods the opposing force is provided by at least a second propeller oriented so as to oppose the force of the first propeller. By independently controlling multiple propeller speeds the vessel can be steered.

Another method for mixing the contents of a manure pit includes: lowering a first propeller from a vessel floating in the pit; rotating the first propeller to stir up the pit contents; and controlling the position of the vessel in the pit at least in part by a tether secured to the vessel and to a device external to the manure in the pit. The method can include the propeller lowering including lowering a first elongate member having the first propeller near the first elongate member far end and the first member near end pivotally secured to the vessel. Methods can have the first propeller rotating including driving the propeller from a first motor operably secured to the first elongate member and coupled along the member to the first propeller. The lowering can include controlling the length a first cable secured to the first elongate member far end and at a second cable end to the vessel. The pit manure level can be allowed to fall through pumping out the pit while the boat is in the pit and also raising the first propeller when the pit becomes much shallower. The propeller rotating can be performed at least partially within a propeller guard or foot to prevent the propeller from directly touching a side or bottom of the pit.

Some vessels include a second propeller, second elongate member, second motor, and second cable, and the method also includes lowering, rotating, and controlling the second propeller. The position of the vessel can be controlled at least in part by independently controlling the rotational speed of the first and second propellers. Some vessels include a third and fourth propeller, third and fourth elongate member, third and fourth motor, and further comprises lowering, rotating, and controlling the third and fourth propellers. The propeller lowering can include disposing the propellers outward and away from the vessel and at less than a 45% angle from horizontal such that the propellers provide a propulsion force to propel the vessel.

### DESCRIPTION OF THE DRAWINGS

FIG. 1 is a schematic view of one single propeller embodiment boat with the steering not shown.

FIG. 2 is a schematic view of the single propeller boat of FIG. 1 having a pivoted steering arm for moving a land-anchored cable across the boat centerline, with only the steering shown.

FIG. 3 is a schematic view another single propeller embodiment boat having a slidable attachment point for moving a land-anchored cable across the boat centerline, with only the steering shown.

FIG. 4 is a schematic view of the single propeller boat FIG. 1, with a high level view of the controls shown.

FIG. 5 is a side top view of the single propeller boat of FIG. 1 mounted on a trailer.

FIG. 6 is a rear view of the single propeller boat of FIG. 1 mounted on a trailer, showing the steering arm and associated hydraulic cylinder.

FIG. 7 is a fragmentary side view of the rear of the single propeller boat of FIG. 1 mounted on trailer showing the steering arm and winch for raising and lowering the agitator arm.

FIG. 8 is a rear side view of the single propeller boat of FIG. 1 on a trailer showing the agitator arm, propeller, and propeller foot.

FIG. 9A is a rear view of the single propeller boat of FIG. 1 having the steering arm and a cable in second position.

FIG. 9B is a rear view of the boat of FIG. 9A having the steering arm and cable in a first position to change the angle of the boat from FIG. 9A with respect to the cable and also change the direction of propulsion of the boat.

FIG. 10 is a schematic view of one four propeller embodiment boat of the invention.

FIG. 11 is a schematic view of the four propeller of FIG. 10, with a high level view of the controls shown similar in some respects to FIG. 4.

FIG. 12 is a top side view of the four propeller boat of FIG. 10 mounted on a trailer.

FIG. 13 is a fragmentary side view of the rear of the four propeller boat of FIG. 10 mounted on a trailer, showing the propeller guards and feet and the hydraulic fluid cooler.

FIG. 14 is a fragmentary rear side view of the four propeller boat of FIG. 10 mounted on a trailer, showing a winch for lowering two agitator arms and the collars for controlling lateral movement of the agitator arms.

FIG. 15 is a perspective view of the four propeller boat of FIG. 10 in use in in a manure lagoon, showing the agitator arms urged outward over the pontoons and lowered into the lagoon using the cables disposed over outwardly splayed outrigger arms to raise and lower the arms clear of the pontoons.

FIG. 16 is a close up view of some of the heavier manure layer contents churned, sheared, at least partially mixed, and floating on the lagoon surface.

FIG. 17 is a front view of a remote control unit which can be used to control some manure boats according to the present invention.

FIG. 18 is an end view of a propeller, propeller guard, and a cutting blade next to the propeller.

### DESCRIPTION

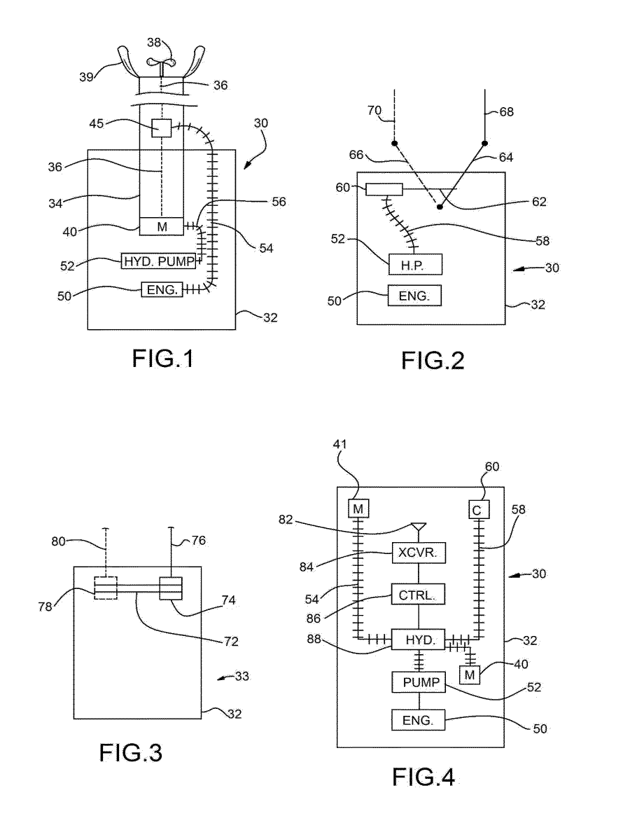

FIG. 1 is a schematic view of one single propeller embodiment boat 30 of the invention having generally a hull/frame 32, with the steering not shown. The hydraulic lines are shown cross hatched. An engine 50 drives a hydraulic pump 52 which powers a motor 40 on the more inboard end of an arm 34 which drives a rotating drive shaft 36 which is disposed along arm 34. Drive shaft 36 drives a propeller 38 which can be protected by one or more propeller guards 39. An arm winch 45 powered through a hydraulic line 54 can be used to raise and lower arm 34 end having propeller 38 into the lagoon. The arm 34 region having motor 40 can be pivotally coupled to boat 30, allowing arm 34 to be used at various angles with respect to horizontal.

FIG. 2 is a schematic view of single propeller boat 30 of FIG. 1, with only the steering shown. The hydraulic lines are shown cross hatched. This embodiment is steered by pivoting a steering arm 64 from side to side so as to change the cable attachment point with respect to the vessel center line. In this embodiment, steering arm 64 is controlled by a hydraulic cylinder 60 and driven rod 62 powered through a hydraulic line 58. First position 64 and second position 66 of the steering arm are shown, with second position 66 drawn in dashed lines. A cable is attached to the steering arm, shown in first position 68 and in second position 70.

FIG. 3 is a schematic view another single propeller embodiment boat 33 of the invention, with only the steering shown. Boat 33 is similar to boat 30 but has a different steering mechanism. The hydraulic lines are shown cross hatched. This embodiment 33 is steered by moving the cable attachment point from side to side along a rod 72 so as to change the cable attachment point with respect to the vessel center line. The change in positions can be effected by various actuators and motors. First and second positions 74 and 78 of the cable attachment point are shown respectively, with the second position drawn 78 in dashed lines. The respective first cable position 76 and second cable position 80 are also shown. Such cables can be secured to land, the shore, a tractor on the shore, and the like.

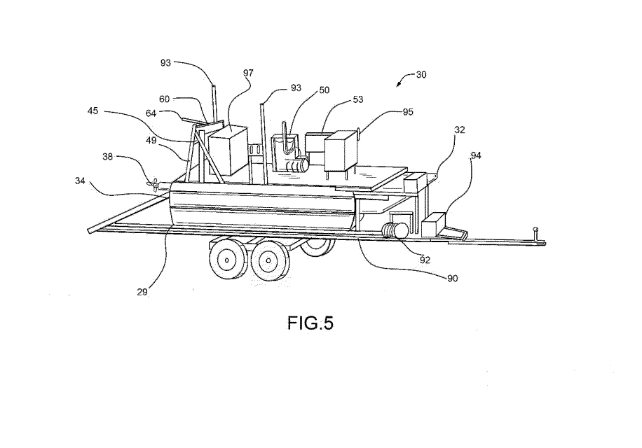

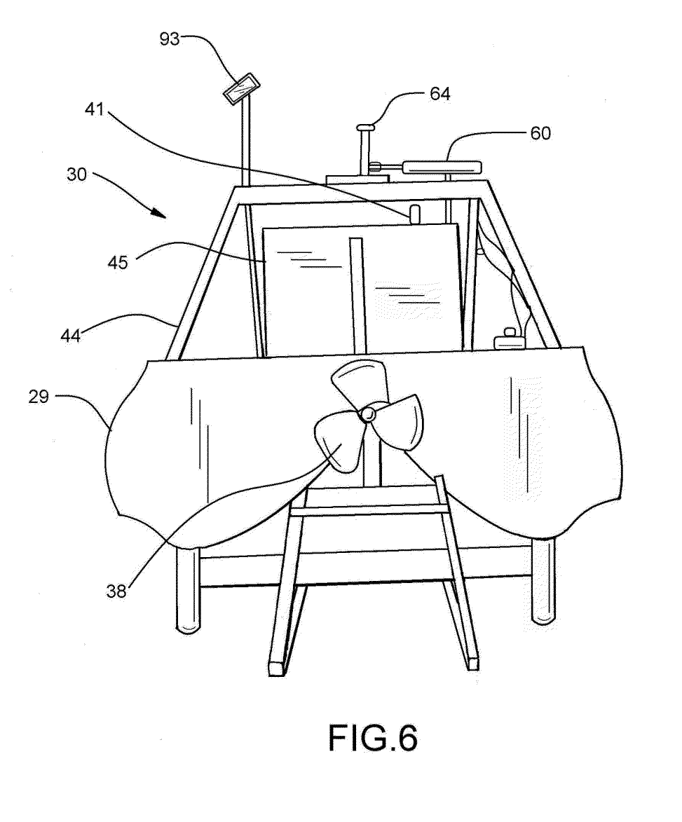

FIG. 4 is a schematic view of single propeller boat 30 of FIG. 1, with a high level view of the controls shown. Radio remote-control signals can be received by a receiver or transceiver 84 through an antenna 84 which is coupled to electronics 86 to convert D/A and A/D and perform other logic, control, and conversion functions. Some embodiments also have an angle sensor on agitator arm 34 to calculate the depth of the propeller based on the angle. Such information can be used to report out the propeller depth and/or locally limit the depth of the propeller on the boat. The depth can also be used to interlock to not allow propeller rotation until the propeller is beneath a certain depth. The analog and/or digital signals from electronics 86 can be coupled to interposed hydraulic controls 88 such as solenoids, valves and the like, represented by the single box 88 in FIG. 4. The controlled hydraulic lines (or electric signals directly) can be used to change engine settings to engine 50, the arm winch motor 41, hydraulic pump 52, steering arm control cylinder 60, propeller motor 40, and the directions and speeds of these devices, and other functions.

FIG. 5 is a side top view of the single propeller/agitator boat 30 of FIG. 1 mounted on a trailer 90. This view shows two pontoons 29, single propeller 38, and rear winch 45 on a winch post with a hydraulic motor for raising and lowering agitator arm 34. Also shown are top mounted lights 93, steering arm 64, fuel tank 97, hydraulic fluid tank 95, hydraulic fluid cooler 54, and a trailer mounted motor driven winch 92 with motor 94 for putting the boat 30 into the lagoon and pulling the boat out of the lagoon. Steering arm 64 can be coupled to a cable secured to the edge/shore of the lagoon and/or a tractor on the shore/edge. Changing the angle of steering arm 64 can change the angle of the boat and propeller with respect to the cable and be used to steer the boat. Steering can use steering arm 64 which can be pivoted to bring the far end of steering arm 64 from one side of the center line of the boat across the center line and to the opposite side of the boat. Putting the cable off-center can make the boat change angular orientation.

FIG. 6 is a rear view of the single propeller/agitator boat 30 mounted on a trailer. This view shows two pontoons 29, single propeller 38, steering frame 44, rear winch 45 for raising and lowering the agitator arm 34, a winch hydraulic motor 41, top mounted light 93, steering arm 64, and hydraulic cylinder 60 for moving steering arm 64.

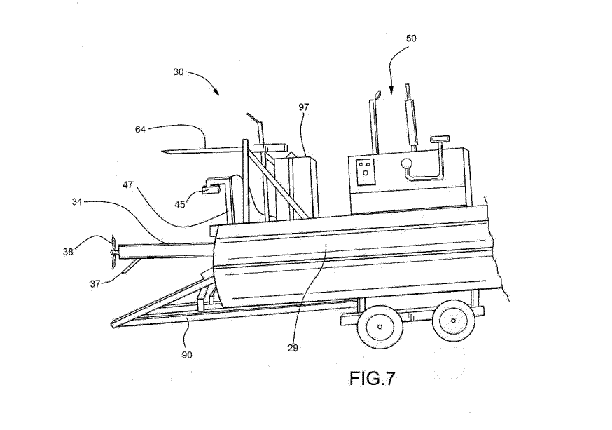

FIG. 7 is a side view of the rear of the single propeller boat 30 mounted on trailer 90. Propeller 38 is shown having an arm extending downward and rearward and carrying a bottom plate or foot 37 for keeping propeller 38 from contacting and harming the bottom of the lagoon. Propeller 38 is mounted to agitator arm 34 having a rotating shaft (not shown) therethrough. Rear winch 45 mounted on winch post 47 raises and lowers agitator arm 34 through a cable. Steering arm 64 is shown from the side. Engine 50 and fuel tank 97 are also shown.

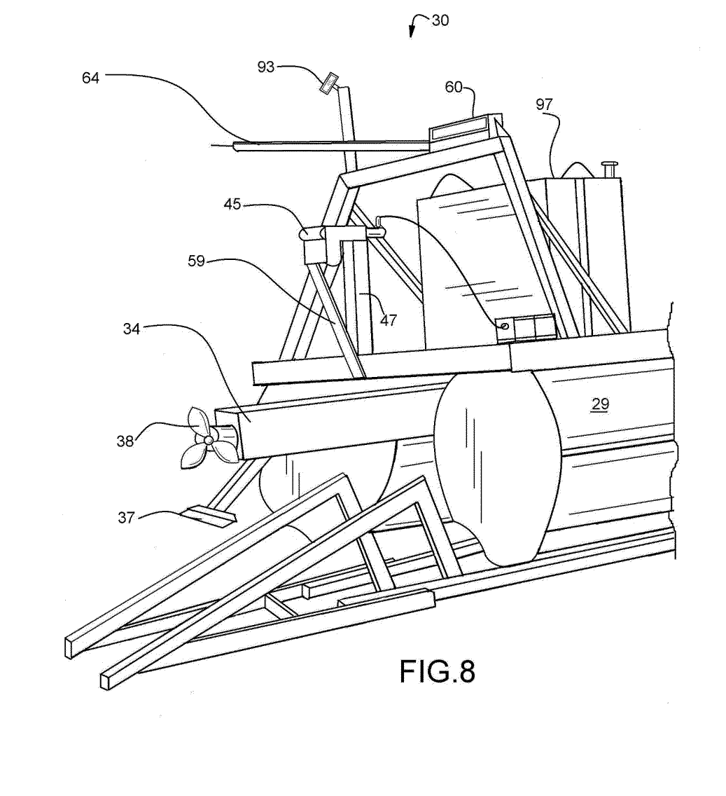

FIG. 8 is a rear side view of the single propeller boat 30. Propeller foot 37 is again shown. A winch cable 59 connecting winch 45 on post 47 to agitator arm 34 is also shown. In this embodiment, the agitator arm is about 15 feet long. In various embodiments, the agitator arm may vary from 10 feet to 20 feet in length. The pontoons in the illustrated embodiment are about 24½ feet long and about 8 or 9 feet apart.

Steering arm 64 can be coupled to a cable secured to the edge/shore of the lagoon and/or a tractor on the shore/edge. Changing the angle of the steering arm can change the angle of the boat and propeller with respect to the cable and be used to steer the boat. In other embodiments, the cable position relative to the center line can be achieved using a purely side to side actuator movement of the cable attachment location rather than a pivot.

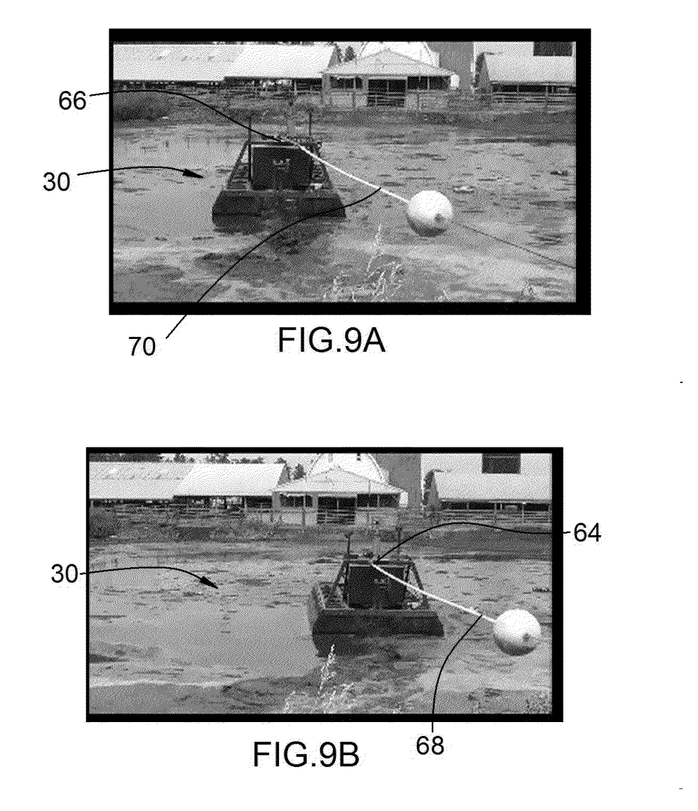

FIG. 9A is a rear view of single propeller boat 30. The steering arm in second position 66 is coupled to a cable in second position 70. Steering arm 64 is shown oriented to the right and somewhat in-line with the cable.

FIG. 9B is a rear view of the boat 30 of FIG. 9A having steering arm rotated to the left at 64, forming an angle with the cable at 68. Changing the angle of the steering arm can change the angle of the boat with respect to the cable and also change the direction of propulsion of the boat. The boat can thus be moved from side to side using the steering arm. The amount of cable let out can control the distance from the edge of the lagoon. In some embodiments, the steering arm position, propeller direction and speed, agitator arm winch, and other functions can be remotely controlled from an operator at the edge of the lagoon. The cable can be coupled to a tractor which can also move along the edge of the lagoon from side to side and cover even more of the lagoon. The agitator arm can also be remotely controlled and raised and lowered to control the depth at which the propeller is reaching. The power/RPM driving the propeller can also be controlled remotely. In some embodiments, the agitator arm can be lowered to an angle from horizontal of about 30 degrees or more.

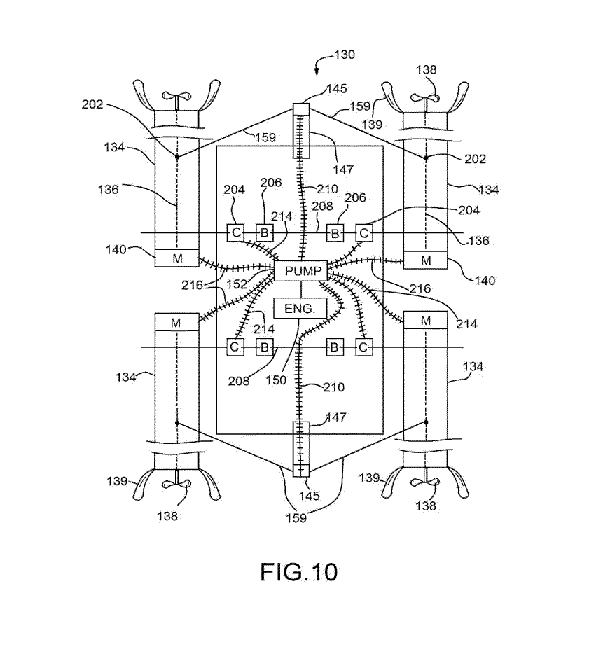

FIG. 10 is a schematic view of one four propeller embodiment boat 130 of the invention. The hydraulic lines are shown cross hatched. An engine 150 drives a hydraulic pump 152 which powers a motor 140 on each of the more inboard ends of an arm 134 which drives a rotating drive shaft 136 which is disposed along arm 134. Drive shaft 136 drives propeller 138 which can be protected by one or more propeller guards 139. An arm winch 145 mounted on a winch post 147 can be used to raise and lower arm 134 ends having propellers 138 into the lagoon. In this embodiment, the front two arms 134 are raised and lowered together and the rear two arms 134 are raised and lowered together through winch cables 159 attached to arms 134 at anchor points 202. In some embodiments, the winch cables are run over pulleys or rollers atop upwardly and outwardly splayed arms which extend up, over, and to the outside of the pontoons. The inboard arm regions having motors 140 can be pivotally coupled to the boat through shafts or axles 208 riding on bearings 206 allowing arms 134 to be used at various angles with respect to horizontal. Arms 134 can be pushed outward and retracted inward through hydraulic cylinders 204 powered through hydraulic lines 214. A hydraulic pump 152 can drive arm winch 145 through hydraulic motor 141 (not shown in FIG. 10) through hydraulic line 210.

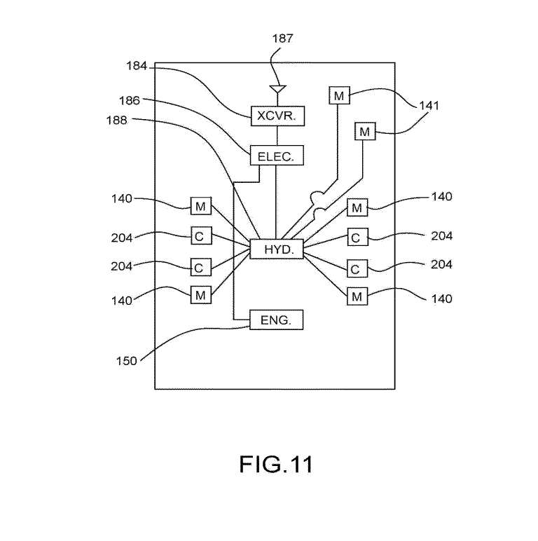

FIG. 11 is a fragmentary schematic view of single propeller boat 130, with a high level view of the controls shown similar in some respects to FIG. 4. Radio remote control signals can be received by a receiver or transceiver 184 through an antenna 187 which is coupled to electronics 186 to convert D/A and A/D and perform other logic, control, and conversion functions. Some embodiments also have an angle sensor on agitator arm 134 to calculate the depth of the propeller based on the angle. Such information can be used to report out the depth and/or locally limit the depth of the propeller on the boat. The propeller depth can also be used to interlock to not allow propeller rotation until the propeller is beneath a certain depth. The analog and/or digital signals from electronics 186 can be coupled to interposed hydraulic controls 188 such as solenoids, valves and the like, represented by the single box 188 in FIG. 4. The controlled hydraulic lines (or electric signals directly) can be used to change engine settings to engine 150, arm winch motors 141, the hydraulic pump, propeller motors 140, the arm lateral push/pull cylinders 204, the directions and speeds of these devices, and other functions. In four propeller boat 130 there are two winch motors 141, four pump motors 140, four propeller motors 140, and four hydraulic cylinders 205.

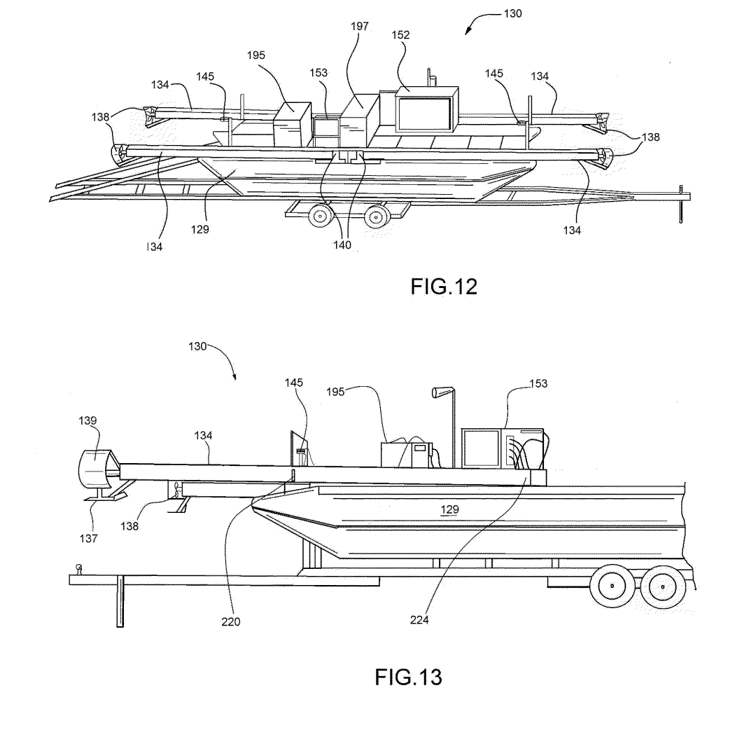

FIG. 12 is a top side view of four propeller boat 130 mounted on a trailer. Boat 130 has a frame, two pontoons 129, and four agitator arms 134 each having a propeller 138 at one end, a motor 140 at the opposite end, and a drive shaft coupling the two. This boat includes an engine 152 for driving a hydraulic pump for powering the hydraulic motors and cylinders and a hydraulic fluid cooler 153 for air cooling the hydraulic fluid. A fuel tank 197 and hydraulic fluid tank 195 are also shown. A rear winch 145 is motor driven and raises and lowers the two rear agitator arms 134 together using two cables, one cable each run over a roller on an arm splayed upward and outward on either side of the winch 145 and anchored to an intermediate portion of an agitator arm. This boat includes a prop side guard and a prop foot near each propeller as previously discussed. The four agitator arms 134 are showed in a stowed position for transport. The arms can each be urged outward by a hydraulic cylinder making them clear the pontoons underneath. In some embodiments, the arms can be pushed about 6 inches outward.

In some embodiments, the following and more can be remotely controlled separately: front arms raising and lowering degree; rear arms raising and lowering degree; each propeller speed; propeller direction, engine speed; engine starting; engine stopping, arm extension side to side; and arm retraction side to side. In this boat the remote control uses a radio remote control unit under control of an operator.

FIG. 13 is a fragmentary side view of the rear of a four propeller boat 130 mounted on a trailer. This embodiment has four propellers 140, each disposed at the end of an agitator arm 134 and protected by propeller guards 139 and feet 137. In this embodiment, two propellers 138 are located at front on either side, and two are located at rear on either side. In this embodiment, the agitator arms 134 are about 15 feet in length. The distance from front propeller to rear propeller in this embodiment is about 36 feet and the propellers in the front and rear are separated from side to side by about 9 feet when stored on the boat and about 10 feet when lowered into the lagoon. In some embodiments, the pontoons are about 24½ feet long and about 8 to 9 feet apart.

A front/outboard collar 220 and center/inboard collar 224 are both shown, constraining the agitator arm 134 while on the trailer. The collars allow the agitator arms to be secured during transport. In some embodiments, the outboard (front and rear) collars 220 can be manually secured and unsecured (to the agitator arms). The center collars 224 can be extended outward past the pontoons and retracted inward over the pontoons by hydraulic cylinders in some embodiments. This allows the agitator arms to be widely apart during use but drawn inward over the pontoons during road transport on the trailer.

A propeller guard 139 protecting the sides of the propeller and foot 137 are as previously described. The propeller guards 140 and feet 137 can protect the lagoon sides/liners during use. A front winch 145 is shown for raising both front agitator arms 134 together using a winch cable disposed over outwardly and upwardly splayed arms. Other embodiments include individual control of the agitator arms on opposite sides of the boat. A hydraulic fluid tank 195 and electric fan assisted cooler 153 are also shown. Unlike most propeller driven vessels, the engine and other cooling can be provided using an air cooler/radiator using air cooling rather than water cooling. This is mainly because the water in question is often a manure slurry with solid chinks which would clog a fluid cooling system, for example, those used in most outboard boat engines. In various embodiments, the propeller motors are hydraulic motors are at least about 10 and less than about 50 HP. In various other embodiments, the motors are at least 20 HP or 30 HP and less than about 40 or 50 HP.

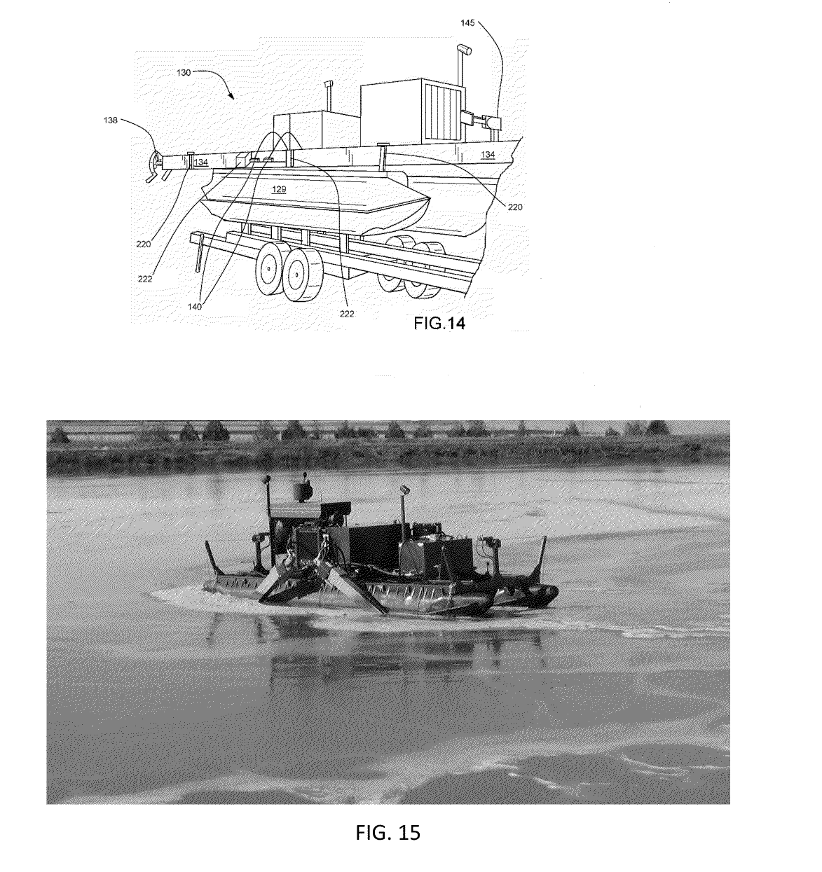

FIG. 14 is a fragmentary rear side view of the four propeller boat 130 of FIG. 13 mounted on a trailer. The front and rear agitator arms 134 are both shown on one side. The collars 220 and 222 for restraining the agitator arms 134 are also shown. The agitator arm propeller motors 140 may also be seen, located at the center/inboard ends of the agitator arms. In some embodiments, these motors are hydraulic motors coupled through rotating shafts to the propellers at the ends. The rear winch 145 is also shown, for raising and lowering the rear agitator arms. The agitator arms 134 are shown retracted over the pontoons for transport.

FIG. 15 is a perspective view of the four propeller boat in use in in a manure lagoon. The front and rear agitator arms have both been urged outward over the pontoons and the agitator arms lowered into the lagoon using the winches and cables. The front and rear winch cables are both disposed over outwardly splayed outrigger arms allowing the cables to be disposed over the agitator arms as they are raised and lowered. In this embodiment, the winch is coupled to a cable on each side coupled to the agitator arm on either side. In this embodiment, both right and left agitator arms are raised and lowered together. In some embodiments, the right and left agitator arms raising and lowering are individually controlled. The heavier manure layer may be seen churned up from the lagoon bottom and visible on the surface. Steering can be accomplished by independently controlling the directions and speeds of the propellers. In use, the front agitator arms can be raised more than the rear agitator arms as the boat front is approaching the manure lagoon edge where the surface of the settled manure is often at a shallower depth. In this way the boat position can be maintained using the rear propeller thrust while the front propellers mix the heavier manure at a shallower depth than the rear. The boat can also do this using the opposite combination of front and rear.

In some embodiments of the multiple propeller versions, each propeller can have the RPM independently controlled. The direction and speed of the boat can this be controlled. The boat can be backed into shallower lagoon regions, churning up the settled manure. The boat can be rotated using variations of the propeller RPMs.

In some embodiments, the agitator arm raising and lowering, the agitator/propeller RPMS can be controlled remotely using radio control technology. This allows the operator to control the boat position, speed, orientation, and depth of agitation from the edge of the lagoon or even further away.

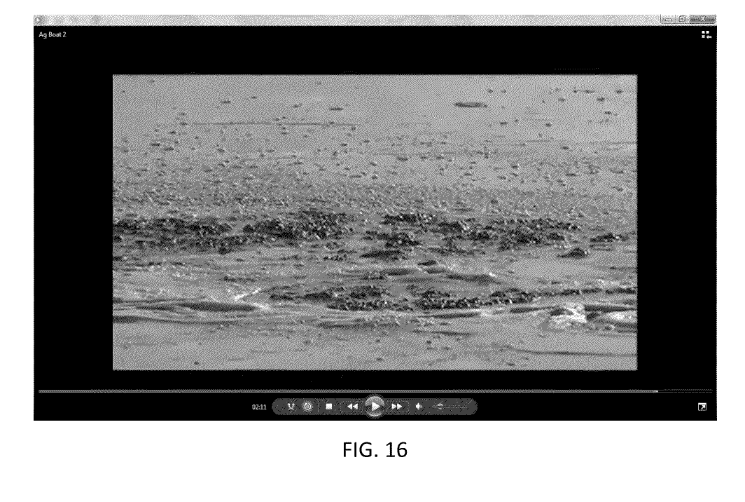

FIG. 16 is a close up view of some of the heavier manure layer contents churned, sheared, at least partially mixed, and floating on the lagoon surface.

Some embodiments include agitating a manure lagoon using propellers which do not directly touch the heavier manure solids layer. This can be done by generating sufficient force and shear forces to dislodge the heavier manure layer and mix it with the lighter manure layer above. Some embodiments do this at least in part by providing shear plates or blades in very close proximity to the propellers such that solids sucked near or through the narrow gap between propeller and blade/plate are sheared by propeller and blade into smaller particles which mix much easier with the lighter manure layer above. The closest distance between the rotating propeller and blade can be even less than about 1/20^{th} inch in some embodiments. In some methods, the propellers are directed toward the nearest shore to also push the mixed manure closer to shore based pumps. Some methods prevent the agitator arms from extending below 45 or even 30 degrees from horizontal, in part to avoid lifting the boat upward and destabilizing it. One set of propellers can agitate the heavier manure layer while the opposed propellers can maintain the boat's position and keep it from moving further from shore than desired. In this way and others the propeller wash and propeller/blade shear can homogenize the heavy and light manure layers together without lifting the boat too much upward and without having it move off of the shore in response to the propeller wash. As previously discussed, in other methods a cable or cables secured to land or something on the shore can provide the force to oppose the propeller wash.

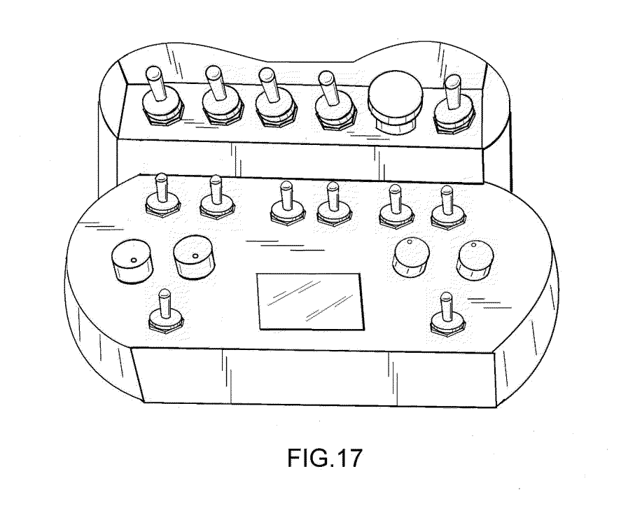

FIG. 17 is a front view of a remote control unit which is used to control some manure boats according to the present invention.

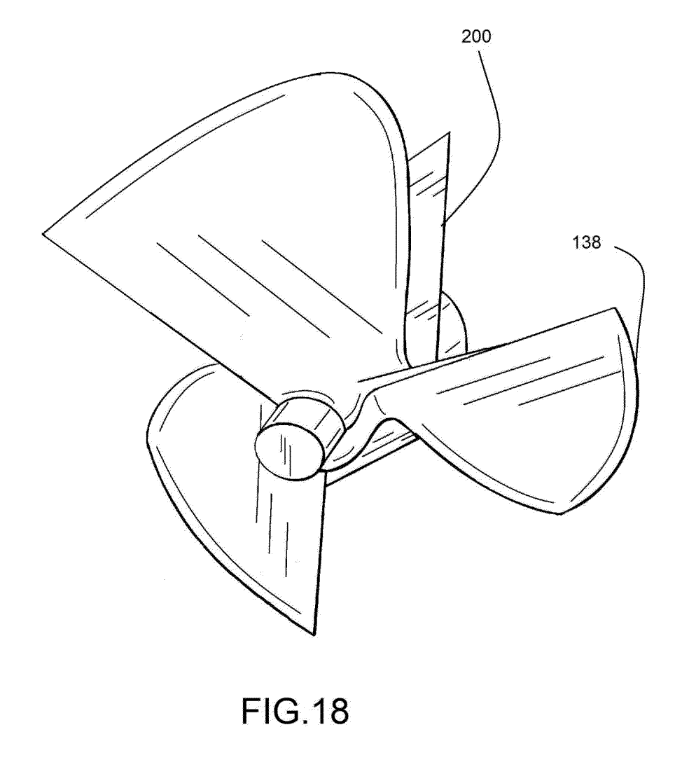

FIG. 18 is an end view of a propeller 138, propeller guard 139, and a cutting blade 200 next to the propeller. In this embodiment, the fore portion of the propeller is flat and closely fits the cutting blade. The propeller and blade can overlap along this close gap for at least 3, 4, or more inches out from the center of the drive shaft. In some embodiments the propeller and blade are less than 1/20 inch apart.

Some embodiments of the invention also provide a system including a remote control transmitter on the shore used to remotely control the manure agitation boats. In some methods the shore based transmitter can also receive data from the manure agitation boat.

We claim:

1. An apparatus for dislodging manure from a manure lagoon, the apparatus comprising:
a floating vessel;
an engine on the vessel;
an arm having a distal end, distal region, proximal region, and proximal end, where the distal end is further from the vessel than the proximal end;
a propeller secured to the arm distal region;
a motor operably coupled to the propeller to rotate the propeller;
wherein the arm is coupled to the vessel such that the distal end can be lowered into the lagoon; and
in which the propeller can be rotated by the motor after the lowering.

2. The apparatus of claim 1, in which the propeller is horizontally distant from the vessel after the lowering into the lagoon by at least one yard and in which the propeller can be at least 5 feet beneath the lagoon surface.

3. The apparatus of claim 1 in which the motor is disposed near the arm proximal region and the propeller is disposed near the arm distal region and the motor drives the propeller through a drive shaft along the arm.

4. The apparatus of claim 1 in which the arm can be lowered at least 30 degrees from horizontal.

5. The apparatus of claim 1 in which the arm is coupled to a cable for lowering and raising the arm.

6. The apparatus of claim 1 in which the arm is a least 10 feet long.

7. The apparatus of claim 1 further including a boat control unit controlling the motor, the engine, the engine speed, the propeller speed, and the arm raising and lowering, where the boat control unit can be controlled remotely from the vessel.

8. The apparatus of claim 1 in which the apparatus includes at least two propellers, two arms, and two motors.

9. The apparatus of claim 1 in which the apparatus includes at least three propellers, three arms, and three motors, wherein one of the three propellers is located on the opposite front/rear side of the vessel from the other two propellers.

10. The apparatus of claim 1 in which the apparatus includes at least four propellers, four arms, and four motors, wherein two of the four propellers are located on the opposite front/rear (fore/aft) side of the vessel from the other two propellers.

11. The apparatus of claim 8 in which the speeds of the propellers can be controlled independently of the other propellers.

12. The apparatus of claim 1 further including a remotely controlled steering member having a movable cable attachment point for moving the cable attachment point to various locations on either side of the vessel center line such that the angular direction of the vessel can change when the attachment point is moved while the vessel is being propelled.

13. The apparatus of claim 1 in which the propeller is used for both manure agitation and propulsion of the vessel.

14. The apparatus of claim 8 in which the vessel can be steered by varying the speed of the propellers.

15. The apparatus of claim 10 in which the arms have a first position such that the arms on opposite sides of the vessel are less than 10 feet apart and a second position such that the arms on opposite sides of the vessel are greater than 10 feet apart.

16. The apparatus of claim 10 in which the arms have a first position such that the arms on opposite sides of the vessel are vertically over at least part of the vessel below and a second position not over the vessel below such that the arms on opposite sides of the vessel can be lowered into the manure water mixture on which the vessel floats.

17. The apparatus of claim 10 in which the arms are coupled to actuators which can move the arms between the first and second positions.

18. A method for agitating manure in a lagoon, the method comprising:
agitating the manure using a floating vessel in the lagoon having a propeller directed toward the lagoon edge where the propeller is rotated so as to urge the vessel away from the lagoon edge; and
applying an opposing force to oppose the propeller horizontal force so as to urge the vessel toward the lagoon edge, where the opposing force can both maintain vessel position with respect to the edge and move the vessel closer to the edge.

19. The method of claim 18 in which the opposing force is provided by tension on a tether connected between the vessel and an object disposed beyond the lagoon manure edge.

20. The method of claim 18 in which the opposing force is provided by at least a second propeller oriented so as to oppose the force of the first propeller.

21. The method of claim 18 further including at least an additional propeller independently controlled in speed where the independent speed can be used to steer the vessel.

22. The method of claim 19 further including steering the vessel by varying the location at which the tether is connected to the vessel with respect to the vessel centerline.

23. The method of claim 18 in which the manure is sucked through the propeller and sheared between the propeller blades and a cutting blade or plate.
